(19) United States
(12) Patent Application Publication
(10) Pub. No.: US 2009/0037249 A1
(43) Pub. Date: Feb. 5, 2009

(54) Forecasted Currency Exposure Management

(76) Inventors: Corey D. Edens, Scottsdale, AZ (US); Wolfgang J. Koester, Paradise Valley, AZ (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/833,172

(22) Filed: Aug. 2, 2007

(51) Int. Cl. G06Q 40/00

(52) U.S. Cl. 705/10

(57) ABSTRACT

Methods and apparatuses enable forecast currency risk management. A risk management system receives forecast or prospective transaction data denominated in a first currency. A value of forecast currency exposure is determined for the forecast data respective to a second currency. The system matches hedge data to the forecast currency exposure to determine a net prospective currency exposure, which may indicate under- or over-hedging. To compensate for the net prospective currency exposure, the system determines a hedge action. The net prospective currency exposure can then be revised based on the hedge action, and the hedge action and revised net prospective currency exposure can be reported.

### FIELD

Embodiments of the invention relate to financial management systems, and more particularly to forecasted currency exposure management.

### BACKGROUND

Companies that do business internationally and/or companies that have foreign entities (e.g., subsidiaries) generally have business dealings in multiple currencies. Transactions in a foreign country may be conducted with a different currency than the currency used by the company for financial statements and reporting, for example. Due to the fluctuations in worldwide currency exchange rates, the use of different currencies could result in gains or losses for the company by merely having cash or accounts in different currencies.

Business entities that have gains or losses due to business transactions conducted in a foreign currency may be considered to have “currency exposure,” expressed as a currency pair and a value (e.g., the value of the transaction with the exchange rate applied). Note that the value of the transaction will likely change over time as the exchange rate between the two currencies changes. The risk of gain or loss due to exchange rate movement may be referred to as “currency risk.” A currency risk can exist anywhere in the chain of business between a parent company, to a subsidiary, down to a vendor or customer. A more detailed description of currency risk is provided below. It is sufficient for purposes here to acknowledge that currency risk exists for companies that conduct business (either directly or through a subsidiary) in a currency other than the currency associated with the company's financial reports or legal entities. Many companies are either unaware of the risk associated with currency exposure, or unaware of how to manage it. Even companies that are aware of the risk may encounter difficulty in identifying and managing the risk.

Not only does currency risk pose a challenge for companies that have operations in multiple currencies, forecasting further complicates currency risk management. To be fiscally sound companies budget and forecast to establish financial expectations for continued operation. Forecasting is essentially an estimated guess at the future financial flows of the company—expected revenue, expected costs, expected expenditures, etc. While a company may correctly predict (at least within certain tolerances) the costs and transaction values for a transaction in a given currency, when those costs and transactions are subject to currency exchange rate movements the company's predictions may be incorrect due to currency risk. To protect against the currency risk associated with prospective transactions, companies frequently hedge, or enter into contracts or agreements that guarantee the value of a transaction in a specific currency. Briefly, a hedge is a financial agreement between a company that has currency risk and a counterparty willing to accept that risk by offering to guarantee the exchange rate. The currency risk is then assumed by the counterparty that offers the hedge.

However, there are regulations regulating the practice of hedging. For preferential accounting treatment (i.e., to realize the full benefit of the hedge), a company must be within specified tolerance (e.g., the “80-125% rule” in current U.S. practice). Achieving favorable accounting treatment is difficult, and generally requires more specific expertise and additional time than is practicable. Additionally, for example, for the typical mid-size corporation, achieving favorable accounting treatment may require expertise and time that is often not available within a company. Thus, currency risk poses a real financial risk to companies with transactions in multiple currencies, especially with regard to forecasting, and yet management of that risk is difficult to accomplish.

### SUMMARY

Methods and apparatuses enable forecast currency risk management. A risk management system receives forecast or prospective transaction data denominated in a first currency where currency exposure is determined to exist for the forecast data respective to a second currency. The system matches existing hedge data to the forecast currency exposure to determine a net prospective currency exposure for each currency pair, which may indicate under- or over-hedging. To compensate for the net prospective currency exposure, the system determines a hedge action. A revised net prospective currency exposure can then be determined based on the proposed hedge action, and the hedge action and revised net prospective currency exposure can be reported.

The comparison of the first and second currencies can compare forecast data for any of a combination of reporting currency or functional currency versus transactional currency. In one embodiment, the forecast data is aggregated for multiple transactions associated with an account. In one embodiment, the forecast data is aggregated for multiple business entities. In one embodiment, the forecast data is aggregated for multiple accounts. In one embodiment, a factor such as a confidence factor is applied to the forecast data to generate a net prospective currency exposure value based on an adjusted forecast data value. The system may determine one or more hedge actions that can be suggested to a system user. The system user may edit, accept, or reject each hedge action. The system may also generate data formatted for executing a financial transaction in response to determining a hedge action.

In one embodiment, the risk management system is provided via an application service provider (ASP) hosted environment accessible via a network. The ASP hosted environment may execute a risk management system that receives inputs and provides information via a browser. The risk management system includes an exposure calculation engine and a decision engine that provides functionality related to identifying and managing currency risk for prospective transaction data.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of an embodiment of a currency exchange model managed by a risk manager.

FIG. 2 is a block diagram of an embodiment of a currency exchange risk manager that receives exchange rate information.

FIG. 3 is a block diagram of an embodiment of a currency exchange risk manager that assesses risk in view of hedge data.

FIG. 4 is a block diagram of an embodiment of a currency exchange risk manager coupled to a business entity.

FIG. 5 is a flow diagram of an embodiment of a process for managing currency exposure risk.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Methods and apparatuses enable forecast currency risk management. A risk management system receives forecast or prospective transaction data denominated in a first currency. A value of forecast currency exposure is determined for the forecast data respective to a second currency. The system identifies forecast currency exposure responsive to the input data. The system also obtains and matches hedge data to the forecast currency exposure to determine a net prospective currency exposure, which may indicate under- or over-hedging. To compensate for the net prospective currency exposure, the system determines a hedge action. The system thus presents potential currency risk, and identifies one or more actions to manage the risk. The net prospective currency exposure can be revised in the system based on the hedge action, and the hedge action and revised net prospective currency exposure can be reported. In one embodiment, the system provides the ability to execute a hedge action directly from the system.

Thus, the ability of a company to manage currency risk can be greatly enhanced. A currency risk management system with forecast capability as described herein enables companies to focus time and energy on understanding and acting upon currency risk, rather than trying to gather and analyze data that will indicate currency risk.

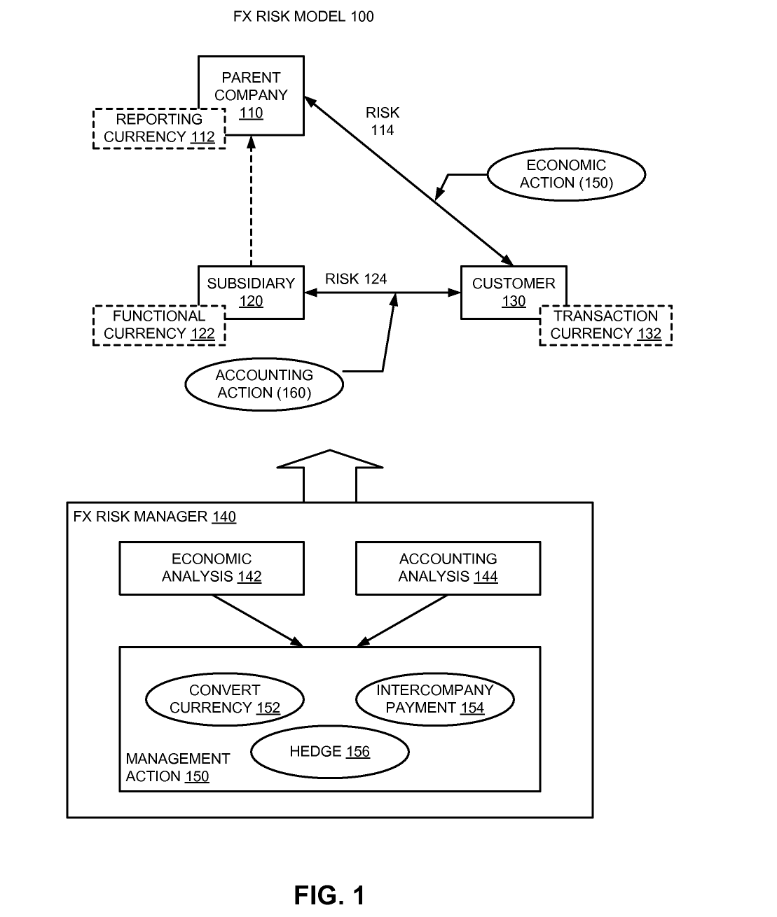

FIG. 1 is a block diagram of an embodiment of a currency exchange model managed by a risk manager. The concepts of currency exposure and currency risk are presented in model 100. As used herein, the abbreviation “FX” (foreign exchange) refers to a currency relationship between a first currency and a second currency. FX risk model 100 illustrates concepts related to the exposure and risks associated with foreign currency.

FX risk model 100 includes parent company 110, which represents any type of business entity, whether corporation, partnership, or some other form, whether for profit or not. Parent company 110 has associated reporting currency 112. Reporting currency 112 represents a currency used by parent company 110 to report financial statements and documents. Typically, though not necessarily, reporting currency 112 is the currency in which parent company 110 normally transacts its business (a functional currency, as described below).

Parent company 110 has subsidiary 120, which represents a subordinate business entity of parent company 110 (which relationship is indicated by the dashed line). While many different types of relationships are possible between parent company 110 and subsidiary 120, such as parent company 110 owning subsidiary 120, the commonality is that the financial circumstances of subsidiary 120 affect and/or can be accounted by parent company 110. Subsidiary 120 has associated functional currency 122. Functional currency 122 represents the currency in which subsidiary 120 normally transacts business. Generally speaking, a functional currency is an operating currency or a currency in which a business entity conducts its day-to-day business. Functional currency 122 would generally be the currency of the economic environment in which cash is generated and expended by the entity (e.g., the currency supported by the government under which subsidiary 120 operates, such as U.S. dollars (USD) for a U.S. corporation, Euros (EUR) for a company within a country of the European Union, etc.). In some circumstances, such as when subsidiary 120 is deemed to be an integrated foreign entity (it operates as an extension of parent company 110 rather than as a self-sustaining entity), or when the currency of the economic environment is a hyperinflation currency (e.g., the 3-year inflation rate is approximately 100% or greater), functional currency 122 may be reporting currency 110.

Subsidiary 120 and/or parent company 110 may transact business with customer 130, which can be an end-consumer of goods, a vendor, another business entity of parent company 110, or some other entity. Business transactions with customer 130 may or may not be conducted in functional currency 122. Thus, a third different currency may be introduced in the course of business for parent company 120. That is, transaction currency 132 associated with customer 130 may be the same or different than functional currency 122, either or which may be the same or different than reporting currency 112.

As described above, currency exposure only occurs when different currencies are encountered. Thus, if subsidiary 120 sells products to customer 130, and reporting currency 112, functional currency 122, and transaction currency 132 are the same, no exposure results. When any of the currency pairs is different, currency exposure results for transactions between the different entities.

For purposes of simplicity in description, assume that only subsidiary 120 conducts business transactions with customer 130. When subsidiary 120 transacts business in a currency other than functional currency 122 (which may be referred to as a “nonfunctional currency”), subsidiary 120 may end up with cash, accounts receivable, accounts payable, intercompany receivables, intercompany payables, and/or other monetary balances (generally referred to as “accounts”) that are denominated in a nonfunctional currency. For purposes of simplicity, transaction currency 132 will be discussed as the nonfunctional currency. However, reporting currency 112 could also be considered a nonfunctional currency to subsidiary 120. The transacting of business in transaction currency 132 results in currency exposure for subsidiary 120. The currency exposure is expressed as the value of the transaction and the associated currency pair (functional currency 122 to transaction currency 132), such as USD to EUR, or Pounds Sterling/Great British Pounds (GBP) to Yen. Repeating what is stated above, the currency exposure results from the fact that the value of transaction currency 132 may change over time as compared to functional currency 122. Thus, the value of the transaction will also change, resulting in an unrealized gain or loss. The risk of such a change in value of a transaction is called a “currency risk.” Currency risk resulting from a business transaction where the transaction currency is not the same as the functional currency is referred to as “accounting exposure.” Said another way, currency exposure resulting from a business transaction where the transaction currency is not equal to the functional currency is accounting exposure. Such risk is represented in FX risk model 100 as risk 124. Accounting exposure risk 124 is present from the time of posting a transaction to the time the FX risk is eliminated.

Any currency exposure where the transaction currency is not the same as the reporting currency can be referred to as economic exposure. Economic exposure risk is represented in FX risk model 100 by risk 114 (e.g., where the reporting currency 112 and transaction currency 132 are different).

Both accounting exposure risk 124 and economic exposure risk 114 may result from transactions between a parent 110 or subsidiary 120 and a vendor, a customer, or another subsidiary or other entity owned by parent company 110. Note that currency exposure of any entity of parent company 110 results in a currency risk for the company as a whole.

While the above discussion about model 100 can be understood from the perspective of “the present,” meaning referring to transactions that are completed and/or in process, significant advantage can be had for the ability to manage the currency risk associated with a forecasted or prospective transaction. Forecasting may be considered similar to a budget looking into the future, and refers to predicting sales, expenses, costs, etc. Management of completed transactions may be accomplished as described in co-pending U.S. patent application Ser. No. TBD, entitled, “Method and System for Identifying and Managing Currency Exposure,” filed Jun. 6, 2007. Managing risk for prospective transactions requires additional techniques. In one embodiment, a system for managing forecasting is combined with a system as described in the above-referenced patent application. FX risk manager 140 represents one embodiment of a currency risk management system, or a part of a currency risk management system, which enables parent company 110 to manage the risks present in model 100.

In one embodiment, FX risk manager 140 enables management of risk associated with economic or accounting exposure, and risk associated with completed or forecasted transactions. FX risk manager 140 may include economic analysis 142 and accounting analysis 144. An implementation of FX risk manager 140 may be able to provide risk analysis for economic exposure and accounting exposure, either in parallel, or separately (e.g., via user selection). Typically, a company would only choose to manage either accounting exposure or economic exposure for forecasted transactions, since attempting to manage both concurrently may result in inefficiencies of over-protecting and concurrently monitoring too many variables. Thus, separate analysis and display of either economic exposure or accounting exposure would be the usual implementation, although another implementation is possible.

Economic analysis 142 identifies areas within model 100 where economic exposure exists. Accounting analysis 144 identifies areas within model 100 where accounting exposure exists. Either economic analysis 142 or accounting analysis 144 may result in the suggestion of one or more management action 150. Management action 150 includes actions such as convert currency 152, intercompany payment 154, and hedge 156. Note that convert currency 152, intercompany payment 154, and hedge 156 are effective for management of completed transactions. Management of prospective or forecasted transactions will typically only be accomplished via hedge 156, or some equivalent. That is, convert currency 152 and intercompany payment 154 are not available because they deal with actions on cash-in-hand, which is contrary to what forecasting is about. Thus, reducing forecast exposure is accomplished via one or more suggested hedge actions 156, since the transactions do not yet exist but are predicted to happen in the future.

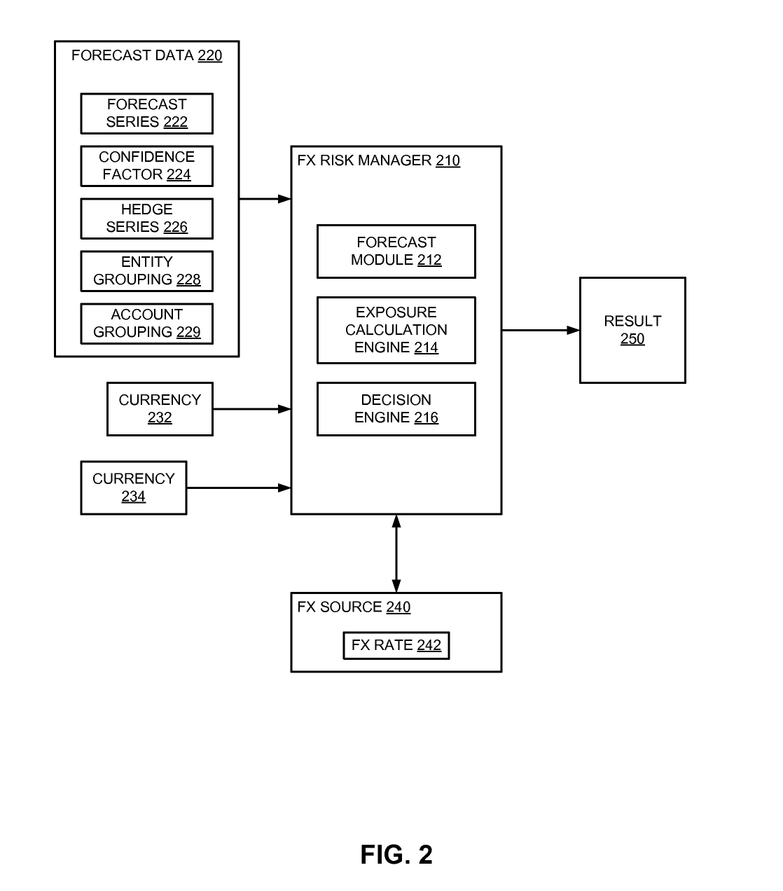

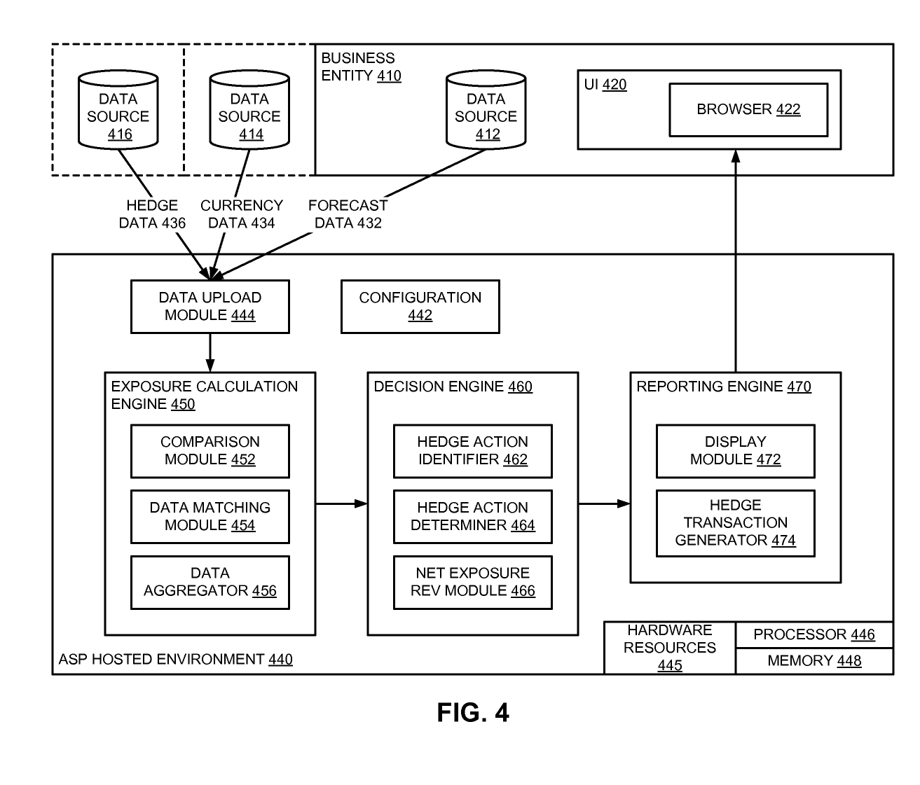

FIG. 2 is a block diagram of an embodiment of a currency exchange risk manager that receives exchange rate information. FX risk manager 210 provides an example of a currency exposure manager according to any embodiment described herein. FX risk manager 210 includes forecast module 212, which represents one or more modules and/or functionality that enables FX risk manager 210 to provide currency exposure management for forecasting. Specific functionality is described in more detail below with respect to FIG. 4.

FX risk manager 210 receives input that informs the currency exposure/risk analysis. Input data is uploaded into FX risk manager 210. Input data includes forecast data 220, currency 232, and currency 234. In one embodiment, the currencies are not separately loaded, but are an integral part of forecast data 220 (e.g., the uploaded data has an associated field or metadata indicating the currency). Forecast data 220 can include multiple files, multiple tables, spreadsheets, extensible markup language (XML) data, etc. Data can be uploaded as a stream, as a file transfer (e.g., via FTP), or via any other known mechanism. Forecast data 220 may include one or more time series. A time series breaks forecast data 220 into different intervals or sub-periods of a forecast period. For example, forecast data 220 may include forecast information for each month, quarter, etc., for one or more years. There may be one or more time series' for forecasts, one or more time series' for confidence factors (see below), one or more time series' for hedge data (see below), etc.

In one embodiment, forecast data 220 includes forecast series 222. Forecast series 222 may be, for example, table or spreadsheet data that indicates a set of forecast values over a period of time. The forecast values may be for a business entity, an account, particular anticipated transactions, business units, or any other logical separation of data. The data can be customized according to accounting and business practices used by a company. The period of time can be weeks, months, quarters, etc. The granularity of the data may depend on the purpose of the analysis (e.g., long-term planning versus detailed forecasting), practices of the company (e.g., how frequently the company reports out), as well as market conditions (e.g., volatile market conditions or financial environments may inspire a company to take a closer look at forecast numbers). Forecast series 222 represents one or more series. Thus, multiple series could be provided, one for each entity or account, or an aggregated data format may be used.

In one embodiment, forecast data 220 includes confidence factor 224. Confidence factor 224 provides one mechanism to provide for more realistic management of currency exposure. For example, a company may forecast a certain amount of sales for the following year. However, due to an unexpected increase in demand, or alternatively, a sharp decline in demand, the expectations will not equal the actual numbers. Depending on the market, how long the company has been established, known business relationships or partnerships, time horizon, etc., a company may have a certain level of confidence in the predictions generated in expense, revenue, and/or cost forecasts. In one embodiment, a company generates a confidence factor series that matches forecast series 222 in what entity/account the series is applied to, and over what interval/time period. In a simple implementation, a confidence factor series can be a series of percentages (e.g., 0.9, 0.9, 0.8, 0.7, 0.6, . . . ) by which a transaction forecasts can be multiplied to generate forecast data adjusted for how much confidence a company has in realizing its forecasts. It will be understood that although a confidence factor is described, any factor could be used for any purpose to apply to the forecast transaction data to create adjusted forecast data. One advantage to performing an analysis using adjusted forecast data rather than raw forecasts is that the risk of over- or under-hedging can be reduced. Confidence factor 224 is associated or otherwise linked to a particular group, account, entity, etc., to indicate where the factor should apply in the forecast analysis.

Currency 232 and currency 234 can be different currencies, and are related by a time-varying currency exchange rate. Currency 232 and currency 234 represent any combination of reporting currency, functional currency, and transaction/nonfunctional currency. The currency exchange rate, FX rate 242, is obtained from FX source 240. FX source 240 represents any of a number of currency exchange rate sources (e.g., Reuters, web service sites, etc.) where currency exchange rates may be obtained. FX rate 242 may include data indicating prices from prior closes, end of month close, end of week close, end of day close, current price, etc.

In one embodiment, the sending of the forecast data triggers FX risk manager 210 to perform a currency exposure analysis and possibly provide possible exposure reduction suggestions. FX risk manager 210 includes exposure calculation engine 214, which performs exposure/risk analysis on forecast data 220. Exposure calculation engine 214 receives forecast data 220, currencies 232 and 234, and FX rate 242, and analyzes the data with one or more algorithms with the various data as input parameters. Exposure calculation engine 214 identifies potential exposure, and indicates a value of exposure. Where an adjustment factor is provided (e.g., confidence factor 224), exposure calculation engine 214 applies the factor to provide adjusted forecast exposure values.

Decision engine 216 provides logic for the determination of possible exposure reduction actions and for presenting the data to a user. The resulting analysis is presented as result 250, which may be provided as a display on a user device, a report, or as a file that can be accessed on a user device. The display may be interactive to enable a user to select different views of the analysis data. Result 250 can provide a unified view of all accounts where exposure exists, as well as a value of the exposure.

In one embodiment, FX risk manager 210 supports calculation “netting.” Netting refers to the concept of aggregating various separate data elements for joint/concurrent analysis. In one embodiment, forecast module 212 enables FX risk manager 210 to aggregate or group entities (entity netting) and/or accounts (account netting). Data aggregation enables exposure to be counter-balanced against similar exposures, thus identifying and utilizing natural hedges occurring in the data set. Utilizing counter-balancing exposures or natural hedges reduces the overall exposure and also the suggested actions used to reduce the overall exposure. Thus, transaction data can be aggregated and analyzed for all of Europe together, for all accounts to a certain country, for all accounts belonging to a particular entity, etc. Aggregation can also be applied to different items, such as sales and commissions that exhibit the same financial behavior (e.g., they have the same likelihood of occurrence). Aggregation requires the data to be related to the same currency pair (currencies 232 and 234 in FIG. 2). Although the currency pair must be the same, the currency relationship may be the opposite (e.g., accounts having EUR to GBP exposure can be aggregated with accounts where the exposure is GBP to EUR).

Thus, in one embodiment, forecast data 220 includes entity grouping information 228 and/or account grouping information 229. Entity grouping 228 may be a list or other indication of an arbitrary group of entities, some of whose currency pairs are the same, and thus some of whose currency exposures may add together or counter-balance one another. For example, assume that entity A and entity B are in the same netting group. If entity A has a functional currency that is the same as a nonfunctional currency of entity B, and entity B has a functional currency that is the same as a nonfunctional currency of entity A, then the currency exposures of these two entities may counterbalance one another. For example, a GBP to EUR currency exposure in one entity (on either the revenue or expense/cost side) may partially counter-balance an EUR to GBP exposure in another entity.

Similarly, forecast data can be aggregated in a single account group indicated in account grouping 229. For example, revenue and commissions may have the same likelihood of occurrence, and thus be compatible for grouping in a forecast, because their future values are likely to coincide. Note that requiring the same financial behavior is applicable to cases where a factor is chosen to apply to future transactions.

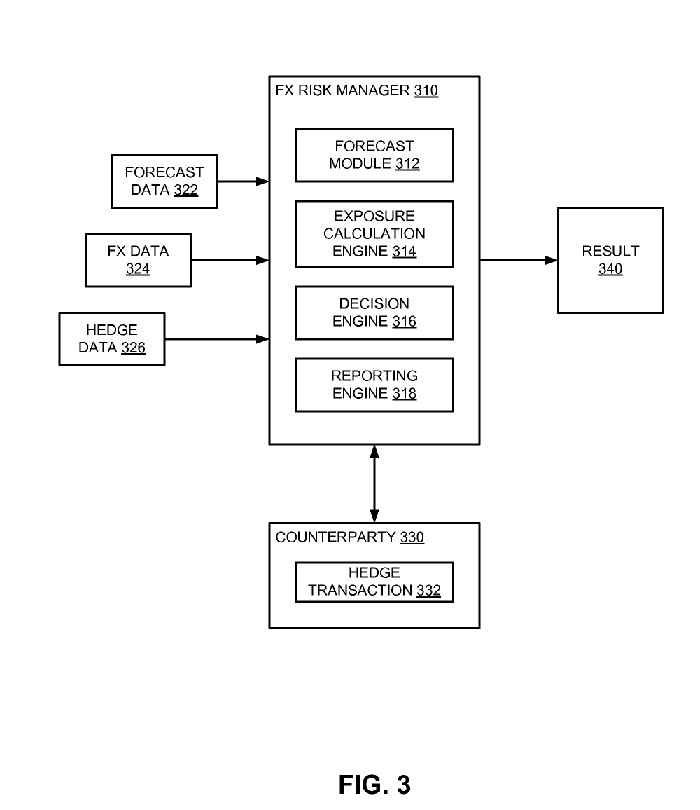

FIG. 3 is a block diagram of an embodiment of a currency exchange risk manager that assesses risk in view of hedge data. The system illustrated in FIG. 3 may be an example of a system according to FIG. 2 or any other embodiment of an FX risk manager as described herein. FX risk manager 310 receives forecast data 322, which may include prospective transaction data, one or more forecast series, one or more factors, netting information, etc., as described above. In one embodiment, FX risk manager 310 retrieves forecast data from a server. Alternatively, the information can be provided as part of an upload operation.

FX risk manager 310 receives FX data 324, which indicates one or more currency pairs for prospective transaction data in forecast data 322 and an associated rate. Note that FX data 324 may indicate data obtained from both a client company (e.g., a company for which an analysis is performed by FX risk manager 310) and an exchange rate source.

In one embodiment, FX risk manager 310 also receives hedge data 326. Hedge data 326 may be retrieved from a database, or may be provided in a similar manner to prospective transaction data, or via any known mechanism for data transfer. Hedge data 326 indicates hedges or derivatives already owned by the company for which the analysis is provided. In one embodiment, hedge data 326 includes a corresponding hedge series for every account group indicated in aggregation information. Hedge data 326 may need to be tied or associated with a group to have the hedge information applied to the group in the analysis.

FX risk manager 310 includes forecast module 312, which represents one or more modules and/or functionality that enables FX risk manager 310 to provide currency exposure management for forecasting. FX risk manager 310 includes exposure calculation engine 314, which performs exposure/risk analysis on forecast data 322. Exposure calculation engine 314 receives forecast data 322, FX data 324, and hedge data 326. Exposure calculation engine 314 performs an exposure analysis on the data to identify potential currency exposure. Such an analysis can include the application of a factor to the data.

In one embodiment, exposure calculation engine 314 receives hedge data 326 and factors the hedge data into the forecast data analysis. For example, a gross forecast exposure may be generated based on forecast data and FX data. The gross forecast exposure can then be adjusted based on hedges already owned by the company. Note that exposure calculation engine 314 needs to match the hedge data to the gross forecast exposure data, based on similarity of currency pairs, to determine the adjusted or net forecast exposure for that currency pair. That is, the hedge data can be analyzed to determine a total of all hedges owned for a particular currency pair. Hedge data 326 can be analyzed by summing all similar individual derivative values (e.g., all Canadian Dollar (CAD) to USD hedges are summed, all GBP to USD hedges are summed, etc.). Hedge data also includes timing information (e.g., a certain value for certain months, quarters, etc.). The timing of the hedges is also determined to apply to the transaction data (e.g., to align timing by aligning the months or quarters of the forecast data with the hedge data. Thus, for each currency exposure, the adjusted or net currency exposure is calculated by subtracting the matching derivative position from each gross currency exposure by time period.

To apply hedge data, all transaction data associated with the same currency pair may be combined to provide a more useful output. In one embodiment, decision engine 316 identifies a net currency exposure (either positive or negative) after the hedge data is applied to the forecast transaction data. An analysis report to the user indicates the currency exposure, if any. Additionally, in one embodiment, decision engine 316 determines one or more hedge actions responsive to the net currency exposure. The hedge actions provide suggestions of how currency risk can be reduced in light of the currency exposure. In one embodiment, a company has a company profile in configuration information (explained in more detail below with respect to FIG. 4) that indicates currency risk tolerances and decision guidelines to suggest hedge actions. The suggested hedge actions are intended to bring the company's overall net forecast currency exposure within the guidelines of the company's foreign currency risk policy. Decision engine 316 may then receive user input responsive to one or more recommended hedge actions that indicate a decision to create, edit, or reject the hedge action. Decision engine 316 may update/revise the company's net forecast currency exposure based on a determined hedge action (e.g., a selected action) to indicate to a user the impact of the recommended changes.

In one embodiment, FX risk manager 310 includes a hedge transaction generator in decision engine 316 and/or reporting engine 318. Conceptually, generating a hedge transaction may be considered a reporting action, although it may likewise be considered a decision functionality. In either case, FX risk manager 310 may in certain embodiments be able to automatically generate a hedge action. For example, if a particular exposure falls within certain threshold bounds indicated by a risk profile, and if a hedge transaction within certain bounds can be obtained, the system may automatically generate the transaction. Hedge transaction generator generates a hedge action to be transmitted to counterparty 330 or another hedge source or hedge provider. The hedge transaction may accompany a request for a hedge transaction, or may operate as a request for the specified hedge transaction.

Hedge counterparty 330 represents one or more entities with which a hedge transaction may be performed. FX risk manager 310 may generate a request for a hedge transaction, which may be responded by a quote from counterparty 330. The transaction may be accepted automatically in certain circumstances, or otherwise can be manually evaluated. In one embodiment, if a transaction is accepted, either manually or automatically, FX risk manager 310 may generate a report or transaction/trade data indicating a buy and a sell currency for the hedge, either a buy or sell amount for the hedge (depending on what type of hedge is desired), and a settlement/value date. The transaction data may also include other information necessary to have the transaction proceed, such as account numbers, bank ID, company ID, security information, etc.

When the company approves a suggested currency action, the system executes the currency transaction in such a way as to ensure price execution quality. The system then sends a transaction confirmation and settlement report to the company and reconciles the currency transactions and positions with the executing counterparty. Counterparty 330 may then generate hedge transaction 332, and confirm the transaction to FX risk manager 310. FX risk manager via reporting engine 318 can update output data (revised net forecast currency exposure, value of owned hedges, etc.) to a user.

Reporting engine 318 generates all output data and provides the output as result 340, which may be, for example, information provided in a web page for a user to browse.

FIG. 4 is a block diagram of an embodiment of a currency exchange risk manager coupled to a business entity. Many of the functional features illustrated here are otherwise described herein, and may not be described in detail here. It should be understood that descriptions elsewhere of the functionality of a risk manager may also be applied to corresponding functional components of FIG. 4.

Business entity 410 represents any business entity for which a currency exposure analysis may be performed. Business entity 410 includes data source 412, which may be a server, a storage system, a database, etc., which includes files or other records defining forecast data 432. Forecast data 432 includes information related to prospective transactions, including forecast series', confidence factors, etc. One or more other data sources 414-416 also provide data for a currency exposure analysis for business entity 410. Either or both of data sources 414-416 may be a part of business entity 410, or the data as illustrated (e.g., currency data 434 and hedge data 436) may be obtained at business entity 410 and provided in a data upload for analysis. Alternatively, data source 414 may be an FX source that provides currency data, such as an exchange rate. Hedge data 436 may be provided, for example, by a hedge manager (e.g., accessing existing hedge account information from an entity that owns and/or manages the company's hedges), or a hedge provider (e.g., a counterparty) that indicates potential hedge transactions that are available to reduce a net currency exposure. Hedge data 436 should thus be interpreted broadly as referring to either preexisting hedge data, as well as potentially referring to hedge transaction information.

In one embodiment, business entity 410 provides forecast data 432 to ASP (application service provider) hosted environment 440 for analysis. ASP hosted environment 440 represents one example of an implementation of an FX risk manager. Although described in reference to an ASP hosted environment, it will be understood that the description of various functional components can be applied to any embodiment of an FX risk manager as described herein. ASP hosted environment 440 (“environment 440”) may include a server accessible via a network, such as the Internet. Specific network interfaces are not illustrated, but are understood by those skilled in the art. Environment 440 includes hardware resources 445, which may include processor 446, memory 448, as well as network interface circuits, storage components, display components, etc. Many hardware resources also include specific drivers or software to enable the hardware resources. Generally, processor 446 may be any type of processor, including central processing unit(s) (CPU(s)), microprocessor(s), microcontroller(s), etc. Memory 448 represents memory resources for temporary storage of data and/or instructions for execution by processor 446. Memory 448 may include one or more types of random access memory (RAM), and/or flash memory. Storage resources may be individual resources or storage systems (e.g., storage area network (SAN) or network attached storage (NAS)). In one embodiment, the hardware resources of environment 440 are distributed among various hardware devices, which may be implemented in individual boxes, or in a rack, as is understood by those skilled in the art.

Environment 440 includes configuration 442. Configuration 442 may represent one or more configuration parameters specific to environment 440 (e.g., server information, server configuration parameters), or represent configuration parameters specific to business entity 410. As configuration parameters for business entity 410, configuration 442 may include a risk tolerance profile for business entity 410. The risk tolerance profile may indicate tolerances established for business entity 410 or threshold levels of acceptable action (e.g., hedges within a certain value, or within a certain time range, should be handled automatically). In one embodiment, the risk tolerance profile can be different for different accounts, different currency pairs, etc. Configuration 442 may include information on a database representing set up information (users, user rights, passwords, entities, functional currency for each entity, netting groups), time-based forecast data, currency-based derivatives (hedges), etc., for business entity 410. Configuration 442 includes data that indicates risk tolerances and decision guidelines to enable environment 440 to suggest hedge actions.

Data upload module 444 enables environment 440 to receive the various items of input data for performing a currency exposure analysis. Data upload module 444 may support any of a variety of protocols for data transfer and/or include APIs (application programming interfaces) for making the data available for different analysis components.

The uploaded data is processed by multiple functional components described below. The functional components may be implemented in software and/or hardware. The components can be part of a single software program or a single hardware module, or alternatively, the components may be distributed among multiple hardware and/or software components. In one embodiment, environment 440 includes exposure calculation engine 450, decision engine 460, and reporting engine 470. It will be understood that the illustrated components are merely representational of the various functional components of a risk management system, and may be labeled (named) differently, and/or implemented in a variety of different ways. Where software components are included, any of a variety of programming languages may be used, including combinations of programming languages.

In one embodiment, exposure calculation engine 450 includes comparison module 452, data matching module 454, and data aggregator 456. Exposure calculation engine 450 generally analyzes and determines a gross and/or a net currency exposure. Comparison module 452 enables exposure calculation engine 450 to identify different currencies and compare forecast transaction data in the different currencies. The comparison results in a gross prospective currency exposure for each currency pair. Data matching module 454 enables exposure calculation engine 450 to align hedge data with transaction data to adjust a gross prospective currency exposure calculation with hedge information. Data matching module 454 may also be responsible for applying a factor to raw transaction data. Data aggregator 456 enables exposure calculation engine 450 to create and implement exposure analysis for different groups (e.g., account and entity netting). Data can also be considered to be aggregated when hedge data is factored into gross prospective currency exposure determinations.

In one embodiment, decision engine 460 includes hedge action identifier 462, hedge action determiner 464, and net exposure revision (rev) module 466. Decision engine 460 may include mechanisms to access configuration 442 to obtain tolerance and analysis information for business entity 410. Such mechanisms may include APIs to access and parse the data. Hedge action identifier 462 enables decision engine 460 to identify what hedge actions are available given a particular analysis. Such identifying may involve identifying all possible actions, which can then be filtered by hedge action determiner 464, which determines what, if any, hedge actions to suggest to a user. Hedge action determiner 464 may filter the list of all possible actions by which actions are permissible under the risk tolerance profile of business entity 410. As examples, a hedge may not be available for less than a certain dollar amount (e.g., less than $1000 USD) and thus may not be identifiable as an option by hedge action identifier; a company may indicate no hedge transactions are to be conducted for data more than 18 months or two years out, etc., and thus hedge action determiner will not recommend such actions even if hedge transactions are available for the disfavored time periods. Hedge action determiner 464 enables decision engine 460 to make specific decisions about what hedge actions will bring business entity 410 to within its identified tolerance. In one embodiment, hedge action determiner 464 may recommend action for economic exposure and not for accounting exposure, assuming a company has decided to manage the economic exposure and not the accounting exposure. Net exposure revision (rev) module 466 enables decision engine 460 to provide updated or revised exposure data to a user based on the recommended hedge actions. Thus, if a user selects one action, net exposure revision module 466 may receive the input information and update the reports based on the selection.

In one embodiment, reporting engine 470 includes display module 472 and hedge transaction generator 474. Generally, reporting engine 470 is responsible for making the analysis and hedge action recommendations accessible to a user. Display module 472 enables reporting engine 470 to drive a display of business entity 410 with the analysis and recommendation data. In one embodiment, as illustrated, business entity 410 may access environment 440 via user interface (UI) 420 with browser 422. Alternatively, UI 420 may provide a representation of business software that includes the logic for interfacing with environment 440. The use of browser 422 may more easily allow the use of standard and/or open interfaces. The open interfaces and browser method may prevent business entity 410 from needing to install business software to access exposure analyses. A secure environment may be provided between environment 440 and UI 420.

In a browser implementation, reporting engine 470 may display a variety of information to a user via a web page showing information such as the forecasted data, hedge data, confidence factors, data series', action recommendations, data layouts for different currency pairs, different entities, different accounts, different groups, etc. All such information may be user selectable, so data is selectively displayable. The web page permits review and human evaluation of the data, and interaction to select recommendations, provide further input, request further actions, etc. Display module 472 updates the web page as data input is changed or as different actions are selected by a user.

Hedge transaction generator 474 enables reporting engine 470 to generate a hedge transaction as described above. Data may be generated and properly formatted for transmission to initiate a hedge transaction. As also discussed above, the generation and sending of the data may be user-controlled and/or automatic, for example, depending on the company's profile. Certain actions may be automatically handled and then reported out. Other actions require user interaction and may likewise be reported out. In one embodiment, reporting engine 470 includes one or more email notification lists and can create and generate emails to provide reports and indicate actions.

Various components referred to herein as modules, clients, engines, or agents described herein may be a means for performing the functions described. Each component described herein includes software or hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which content can be downloaded. A machine readable medium may also include a device or product having content stored thereon at a time of sale or delivery. Thus, delivering a device with stored content, or offering content for download over a communication medium may be understood as providing an article of manufacture with such content described herein.

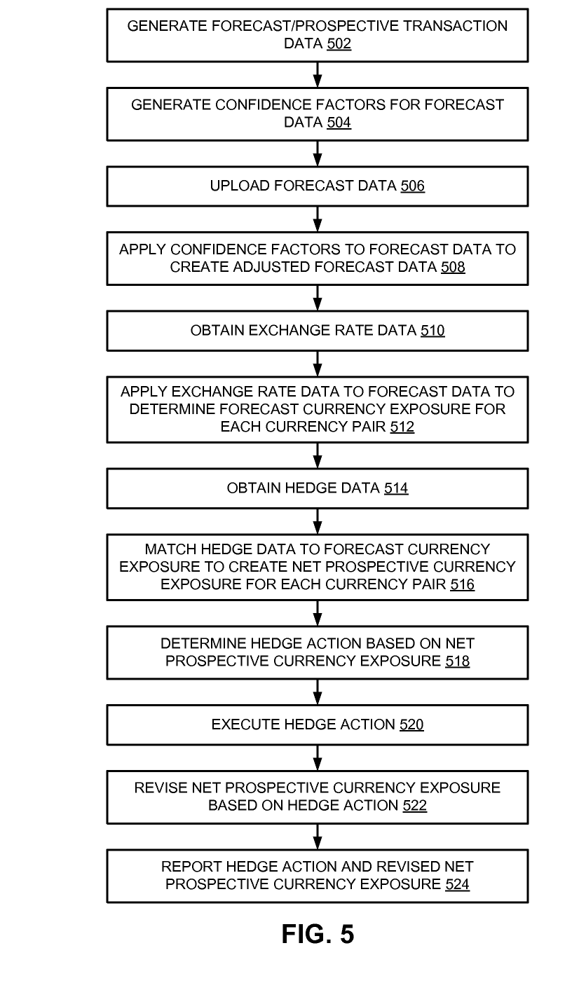

FIG. 5 is a flow diagram of an embodiment of a process for managing currency exposure risk. A flow diagram as illustrated herein provides examples of sequences of various process actions. Although shown in a particular sequence or order, unless otherwise specified, the order of the actions can be modified. Thus, the illustrated implementation should be understood only as an example, and the process for establishing the secure channel can be performed in a different order, and some actions may be performed in parallel. Additionally, one or more actions can be omitted in various embodiments of the invention; thus, not all actions are required in every implementation. Other process flows are possible.

A business entity generates forecast/prospective transaction data, 502. The prospective transaction data indicates transactions expected to occur in the future. The prospective transaction data may be represented in a series, a list, a table, or other form. In one embodiment, the business entity also generates confidence factors for the forecast data, 504. The confidence factors may be represented in a corresponding series, list, or table to be associated with the prospective transaction data. The confidence factors indicate a level of confidence (generally expressed as a percentage) the business has that the transaction will take place. The forecast data, including any confidence factor data, is uploaded to a currency risk management system for analysis, 506.

Where applicable, the currency risk management system applies confidence factors to uploaded forecast data to create adjusted forecast data, 508. The currency risk management system also obtains exchange rate data, 510. The currency risk management system applies the exchange rate data to the forecast data (which could be adjusted forecast data) to determine a forecast currency exposure, 512, for each currency pair. Such a forecast currency exposure can be considered a gross forecast currency exposure.

In one embodiment, the currency risk management system obtains hedge data, 514, which indicates current hedge data for the business entity. The currency risk management system matches the obtained hedge data to the currency exposure forecast data to create a net prospective currency exposure for each currency pair, 516. In one embodiment, the currency exposure forecast is represented as a series, similar to what may be input as forecast transaction data. The hedge data can be obtained in a similar fashion and easily aligned by the system for the data of the correct currency pairs. In other implementations, more determinations may need to be made regarding what data applies to what dates/date ranges, and how to account for the hedge data (e.g., if transaction data is monthly and hedge data is quarterly, the currency risk management system can accumulate the monthly transaction data and apply the hedge data quarterly against quarterly accumulations of transaction data). Note that forecast transaction data may need to be assigned a positive or negative value for application of hedge data; that is, the system can decide which direction is positive and negative with respect to the hedge and transactions of a corresponding currency pair, and then determine how to apply each item of data.

The currency risk management system determines one or more hedge actions based on net prospective currency exposure for each currency pair, 518. The determination may also be based in part on profile data for the business entity. The currency risk management system can execute zero or more of the determined hedge actions, 520. The hedge actions may be executed in response to user input, or in some cases, automatically based on profile rules. Executing the hedge actions can include triggering the hedge actions, generating a transaction form and emailing it to a particular user that will submit it manually, initiating a hedge transaction by requesting a quote that may be reviewed by a user, etc.

The currency risk management system revises the net prospective currency exposure for each currency pair based on selected and/or executed hedge actions, 520. In one embodiment, the revising can be multi-tiered, with different views showing pre-action status, another view showing status as of executed actions, and another view showing projected status based on actions that may be pending approval or are suggested. The currency risk management system reports any hedge actions and the revised net prospective currency exposure to the business entity, 522.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A computer implemented method comprising:
receiving prospective transaction data denominated in a first currency;
comparing the prospective transaction data in the first currency to a second currency different from the first currency to determine a prospective currency exposure;
receiving hedge data;
matching the hedge data to the prospective currency exposure to determine a net prospective currency exposure;
determining a hedge action responsive to the net prospective currency exposure;
revising the net prospective currency exposure based on the hedge action; and
reporting the hedge action and the revised net prospective currency exposure.

2. The method of claim 1, wherein the first currency is a nonfunctional currency.

3. The method of claim 1, wherein the second currency is a functional currency.

4. The method of claim 3, wherein the functional currency is a reporting currency.

5. The method of claim 1, wherein the prospective transaction data relates a prospective transaction between a parent company and one of an entity, a vendor, and a customer, of the parent company.

6. The method of claim 1, wherein the prospective transaction data relates to a prospective transaction between an business entity belonging to a parent company and one of a vendor of the business entity, a customer of the business entity, and a second entity of the parent company.

7. The method of claim 1, wherein the prospective transaction data comprises data aggregated from multiple prospective transactions associated with an account.

8. The method of claim 1, wherein the prospective transaction data comprises data aggregated from multiple prospective transactions each associated with one of a plurality of related accounts.

9. The method of claim 1, wherein the prospective transaction data comprises data aggregated from multiple prospective transactions each associated with one a plurality of business entities belonging to a parent company.

10. The method of claim 1, further comprising:
applying a factor to the prospective transaction data creating adjusted prospective transaction data; and
wherein comparing the first currency of the prospective transaction data to a second currency different from the first currency to determine a prospective currency exposure comprises:
comparing the first currency of the adjusted prospective transaction data to a second currency different from the first currency to determine a prospective currency exposure.

11. The method of claim 10, wherein applying the factor comprises:
applying a time series of confidence factors to a time series of prospective transaction data.

12. The method of claim 1, wherein receiving hedge data comprises:
receiving input from at least one of a user and a computer providing at least a portion of the hedge data.

13. The method of claim 1, wherein determining the hedge action responsive to the net prospective currency exposure comprises:
recommending a hedge action responsive to the net prospective currency exposure; and
receiving input responsive to the recommended hedge action to create the hedge action.

14. The method of claim 13, wherein receiving input responsive to the recommended hedge action to create the hedge action comprises:
receiving user input responsive to the recommended hedge action to create the hedge action.

15. The method of claim 1 as implemented for a business entity, wherein reporting the hedge action further comprises:
generating a report indicating the business entity, a buy currency for the hedge, a sell currency for the hedge, either a buy or sell amount for the hedge, a settlement date, and the revised net prospective currency exposure.

16. The method of claim 1, wherein receiving the prospective transaction data comprises:
receiving a time series indicating prospective transaction data for different intervals of a forecast period.

17. The method of claim 1, wherein receiving the hedge data comprises:
receiving a time series indicating hedge data for different intervals of a forecast period.

18. The method of claim 17, wherein matching the hedge data to the prospective currency exposure comprises:
matching the time series indicating the hedge data with a time series indicating prospective transaction data, including aligning corresponding intervals of the hedge data time series with intervals of the prospective transaction data time series.

19. An article of manufacture comprising a machine readable medium having content stored thereon to provide instructions to cause a machine to perform operations including:
receiving prospective transaction data denominated in a first currency;
comparing the prospective transaction data in the first currency to a second currency different from the first currency to determine a prospective currency exposure;
receiving hedge data;
matching the hedge data to the prospective currency exposure to determine a net prospective currency exposure;
determining a hedge action responsive to the net prospective currency exposure;
revising the net prospective currency exposure based on the hedge action; and
reporting the hedge action and the revised net prospective currency exposure.

20. The article of manufacture of claim 19, wherein the content further comprises content to provide instructions for
applying a factor to the prospective transaction data creating adjusted prospective transaction data; and
wherein comparing the first currency of the prospective transaction data to a second currency different from the first currency to determine a prospective currency exposure comprises:
comparing the first currency of the adjusted prospective transaction data to a second currency different from the first currency to determine a prospective currency exposure.

21. The article of manufacture of claim 19, wherein the content to provide instructions for determining the hedge action responsive to the net prospective currency exposure comprises content to provide instructions for
recommending a hedge action responsive to the net prospective currency exposure; and
receiving input responsive to the recommended hedge action to create the hedge action.

22. The article of manufacture of claim 21, wherein the content to provide instructions for receiving input responsive to the recommended hedge action to create the hedge action comprises content to provide instructions for
automatically executing a hedge action based on a profile.

23. The article of manufacture of claim 19 as implemented for a business entity, wherein the content to provide instructions for reporting the hedge action further comprises content to provide instructions for
generating a report indicating the business entity, a buy currency for the hedge, a sell currency for the hedge, either a buy or sell amount for the hedge, a settlement date, and the revised net prospective currency exposure.

24. An apparatus for managing currency exposure, comprising:
an exposure calculation engine to:
receive prospective transaction data denominated in a first currency;
compare the first currency of the prospective transaction data to a second currency different from the first currency to determine a prospective currency exposure;
receive hedge data;
match the hedge data to the prospective currency exposure to determine a net prospective currency exposure; and
a decision engine to:
determine a hedge action responsive to the net prospective currency exposure;
revise the net prospective currency exposure based on the hedge action; and
report the hedge action and the revised net prospective currency exposure.

25. The apparatus of claim 24, wherein the decision engine is to further:
identify possible hedge actions to reduce the net prospective currency exposure;
determine which of the possible hedge actions are compatible with a risk tolerance profile; and
recommend only the hedge actions compatible with the risk tolerance profile.

26. The apparatus of claim 24, further comprising:
a hedge transaction generator to generate a hedge transaction indicating the business entity, a buy currency for the hedge, a sell currency for the hedge, either a buy or sell amount for the hedge, and a settlement date to accompany a hedge transaction request of a hedge provider.
